(19) United States
(12) Patent Application Publication
(10) Pub. No.: US 2010/0234987 A1
(43) Pub. Date: Sep. 16, 2010

(54) SYSTEM AND METHOD OF AGE VERIFICATION FOR SELLING AGE-RESTRICTED GOODS FROM A VENDING MACHINE

(75) Inventors: Dirk Leonard Benschop, Etten-Leur (NL); Henderik Reinout Benschop, Rozenburg (NL); Sander Ewout Sciarone, Fijnaart (NL)

Correspondence Address: WESTMAN CHAMPLIN & KELLY, P.A., SUITE 1400, 900 SECOND AVENUE SOUTH, MINNEAPOLIS, MN, 55402, US

(73) Assignee: Hollandse Exploitatie Maatschappi j B.V., Etten-Leur (NL)

(21) Appl. No.: 12/279,105

(22) PCT Filed: Apr. 11, 2008
(86) PCT No.: PCT/NL08/50203

§ 371 Date: Aug. 12, 2008

(30) Foreign Application Priority Data
Sep. 13, 2007 (NL) 2000858

(51) Int. Cl. G06F 7/00; G06F 7/04

(52) U.S. Cl. 700/237; 340/5.81

(57) ABSTRACT

The invention relates to a method of vending and authorizing age-restricted goods from a vending system. The vending system comprises a vending machine and a video camera, or equivalent means, for capturing an image of a person desiring purchasing of an age-restricted good. An image of the person is captured and transmitted to a (remote) age verification centre. If, from the person image, it can be determined at the age verification centre that the person is of the required age for purchasing the age-restricted good, a purchase authorization signal from the age verification is received centre at the vending system. Subsequently, the age-restricted good may be provided from the vending machine. On the other hand, if, from the person image, it can be determined at the age verification centre that the person is not of the required age for purchasing the age-restricted good, a purchase denial signal is received from the age verification centre at the vending system. The age-restricted good will then not be provided to the person. In some cases, it will not be possible to determine whether or not a person should be authorized to purchase the age-restricted good. Only in those cases, an identification request signal will be received at the vending system from the age verification centre to present an identification document.

### FIELD OF THE INVENTION

The invention relates to the field of vending machines. More specifically, the invention relates to a system and method of selling age-restricted goods from such vending machines.

### BACKGROUND OF THE INVENTION

Nowadays, goods as tobacco and alcoholic beverages receive increased attention as to their free availability for the under-aged. Instances of selling age-restricted goods to under-age individuals also often result from careless employee verifications of a consumer's age before the consumer purchases age-restricted goods. Commonly, employees who are supposed to be verifying a consumer's age will not even ask for the consumer's identification, and in systems that prompt employees to enter the consumer's birth date, employees often enter a fictitious birth date. Such careless age verification may go unnoticed by a store manager or owner.

On the other hand, government authorities are increasingly willing to enforce fines and license suspension penalties on establishments that sell age-restricted goods to underage individuals. If authorities catch an employee selling age-restricted products to underage consumers, the manager or owner is often held responsible for the employee's actions and may even have their license to sell age-restricted goods revoked as a result of their employee's careless behaviour.

Vending machines are widely known in the field of selling particular goods, such as tobacco and alcoholic beverages. The use of vending machines may be problematic, however, in case of goods that are age-restricted on legal grounds.

US 2002/0087413 discloses a vending machine that includes a video camera for transmitting an image of a buyer to a remotely located human operator, a document reader for transmitting an image of identification document(s) to the remotely located human operator in control of the vending machine. The vending machine has a user interface which gives the appearance that the machine is autonomous even though the operator's approval is required prior to vending an age-restricted item. The machine also includes a payment acceptor and a dispensing apparatus.

In operation, a potential purchaser selects an item for purchase and tenders payment of the item in response to prompts from the vending machine. If the item is an age-restricted item, the potential purchaser is required to provide a photo identification to the document reader. The image is transmitted to the remote human operator who determines the age on the photo identification. If the age on the photo identification is above the legal age for purchase, the operator also determines whether it is the purchaser who is pictured in the photo identification by taking a video image of the purchaser and comparing the image with the photo identification. The operator authorizes the transaction only if it can be determined from the photo identification that the purchaser has the legal age for purchasing the item and if the purchaser is the same person as pictured in the photo identification.

The prior art approach provides a considerable burden for potential purchasers to buy an age-restricted good.

### SUMMARY OF THE INVENTION

It is an object of the invention to provide an improved system and method for selling age-restricted goods.

A method of vending age-restricted goods from a vending system is proposed. The vending system comprises a vending machine and a video camera, or equivalent means, for capturing an image of a person desiring purchasing of an age-restricted good. An image of the person is captured and transmitted to a (remote) age verification centre. If, from the person image, it can be determined at the age verification centre that the person is of the required age for purchasing the age-restricted good, a purchase authorization signal from the age verification is received centre at the vending system. Subsequently, the age-restricted good may be provided from the vending machine. On the other hand, if, from the person image, it can be determined at the age verification centre that the person is not of the required age for purchasing the age-restricted good, a purchase denial signal is received from the age verification centre at the vending system. The age-restricted good will then not be provided to the person. In some cases, it will not be possible to determine whether or not a person should be authorized to purchase the age-restricted good. Only in those cases, an identification request signal will be received at the vending system from the age verification centre to present an identification document.

Furthermore, a method of authorizing vending of age-restricted goods from a vending machine is proposed. The method is performed at an age verification centre. A person image is received from the vending system at the age verification centre of a person desiring purchasing of the age-restricted good. If it can be determined from the person image at the age verification centre that the person is of the required age for purchasing the age-restricted good, a purchase authorization signal is transmitted from the age verification centre to the vending system. On the other hand, if it can be determined from the person image at the age that the person is not of the required age for purchasing the age-restricted good from said vending machine, a purchase denial signal is transmitted. In some cases, it will not be possible to determine whether or not a person should be authorized to purchase the age-restricted good. Only in those cases, an identification request signal will be transmitted from the age verification centre to the vending system.

Moreover, a vending system and an age verification centre for use in these methods are proposed.

It should be noted that the absence of a purchase authorization signal and an identification request signal may also be considered to constitute a purchase denial signal.

The applicant has recognized that in the majority of cases it can be determined solely on the basis of the person image whether or not a person should be authorized to purchase an age-restricted good. The burden of providing an identification document will, therefore, not exist for the majority of potential purchasers. Only in those cases wherein it can not be determined from the live person image whether or not someone is of the required age, an identification document should be presented by the person in question before he will have access to the age-restricted good.

The embodiments of claims 2 and 7 provide the advantage that access to the age-restricted good may still be obtained for a person when the identification document proves that the person in question has the required age.

The embodiment of claim 3 provides the advantage of storing both age-restricted and non aged-restricted goods in a single vending machine. On the basis of operation of the selector, it can be determined whether or not the age verification procedure should be initiated or continued. Moreover, the selector may be used to provide information about the applicable age for a particular selected good on the basis of which the age verification procedure can be initiated or continued.

The embodiment of claim 4 provides that advantage that the potential purchaser may indicate his approval for initiation or continuation of the age-verification procedure in order to comply e.g. with privacy law. Information may be provided to the potential purchaser about the age-verification procedure before confirmation is performed.

The embodiment of claim 5 provides the advantage that persons that do not have the required age are discouraged to make an attempt to purchase the age-restricted good as they have already paid for the good before the purchase authorization signal is received. Consequently, the load of the age verification centre will be reduced.

The embodiment of claim 8 provides the advantage that a single age verification centre can be used for performing the age verification procedure for a plurality of vending systems.

The embodiment of claim 9 provides the advantage that the age determination on the basis of the person image and on the basis of the document image can be performed on different terminals in order to reduce queuing of requests at the age verification centre.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the Drawings:

FIG. 1 shows a schematic illustration of a system comprising a vending system and an age verification centre according to an embodiment of the invention;

FIG. 2 shows a schematic illustration of the vending system of FIG. 1 according to an embodiment of the invention;

FIGS. 3 and 4 shows a communication diagram and a flow chart of a method of operating the system of FIG. 1 according to an embodiment of the invention.

### DETAILED DESCRIPTION OF THE INVENTION

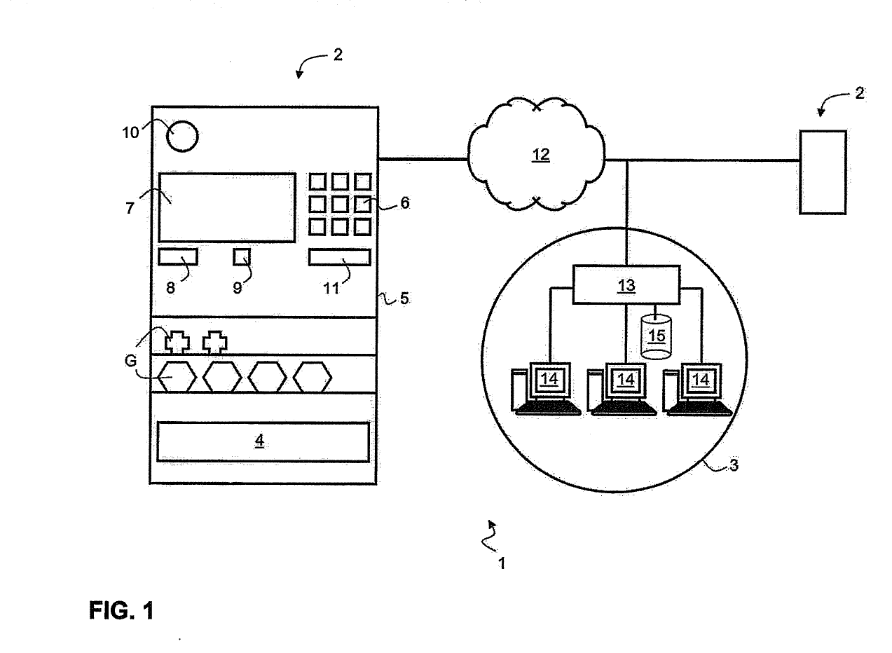

FIG. 1 shows a system 1 comprising a vending system 2 and an age verification centre 3, equipped with authorization means, for authorizing purchase of age restricted goods stored in a vending machine.

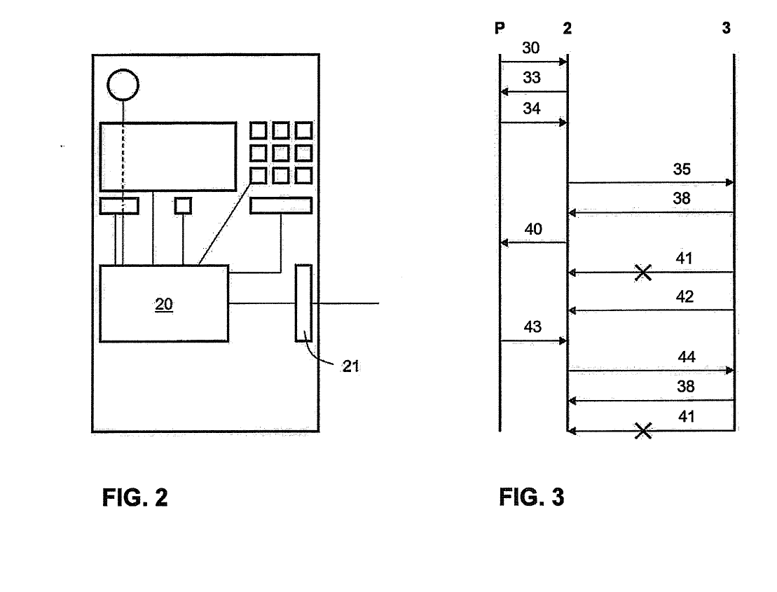

The vending system 2, also shown in FIG. 2 (similar parts have not been provided with reference numbers), comprises a plurality of goods G that for which a legal age-restriction is applicable. The goods G may be disposed in a disposal tray 4 of a vending machine 5, comprising a housing for accommodating the goods G, in a manner known as such. Examples of such goods G are, but are not limited to, alcoholic beverages, tobacco, medicine etc. The goods may be stored in groups of particular group types.

The vending machine 5 of FIG. 1 comprises a selector 6, a display 7, a payment means 8, a confirmation button 9, a video camera 10 and a document reader 11. It should be noted that other components may be present in or on the vending system 2, such as speakers for providing information to a potential purchaser.

The selector 6, provided on the outside of the vending machine 5, comprises a series of buttons. The buttons may be operated by a potential purchaser for selecting a particular one of the goods G in a manner known as such. It should be noted that alternative selection means may be provided, including the embodiment wherein the display 6 is designed as a touch screen.

The display 7 may e.g. be an LCD display. Display 7 may e.g. be used for informing the potential purchaser of the age verification procedure and provide guidance throughout the procedure.

The payment means 8 may be configured for accepting coins or bank notes. The payment means 8 may also be configured for accepting and processing a variety of payment cards, including pre-paid cards, bank cards, customer cards and credit cards. The payment means 8 can be used by a potential purchaser to pay for a good G.

The confirmation button 9 may also be designed to be implemented as an area on a touch screen, e.g. display 7.

The video camera 10 basically represents any means capable of acquiring an appropriate live person image or stream of images of a potential purchaser of at least the face of the potential purchaser. Although the video camera is shown in FIG. 1 to be an integral part of the vending machine 5, it should be noted that the video camera 10 may also be a separate device. The video camera 10 is directed such that an appropriate picture may be made of a person in front of the vending machine 5. The video camera 10 may also be controlled to be aimed at the potential purchaser.

The document reader 11 may e.g. be a scanner or a video camera, configured for accepting an identification document of a potential purchaser, such as a drivers license, a passport, a tourist card etc. It should be noted that the video camera 10 may also be used for generating a document image. In the latter embodiment, the settings of the video camera may be altered in order to enable the video camera to obtain person images and document image of appropriate quality.

The video camera 10 and document reader 11 may operate simultaneously in order to verify by comparison at the age verification centre 3 that the person image and document image are of the same person.

It will be evident that the above-mentioned means of the vending system 2 are all capable of providing and accepting signals. These signals may be controlled or forwarded by a processor module 20, shown in FIG. 2. The vending system 2 may also comprise a memory containing e.g. data about the stored goods G and/or whether or not the good G is an age-restricted goods, possibly also including the applicable age-restriction.

Vending system 2, and in particular vending machine 5, is configured for communicating with the age verification centre 3. Age verification centre 3 is preferably configured for communicating with a plurality of vending machines 5 over a network 12. Vending system 2 comprises a network adapter 21 to allow the vending system to communicate with the age verification centre 3.

The age verification centre 3 comprises a controller 13 for distributing incoming signals, e.g. person images collected by video camera(s) 10 of one or more vending systems 2 and document images collected by one or more document readers 11 of various potential purchasers, amongst a plurality of displays units 14. The age verification centre 3 also comprises a data-base 15, which may represent one or more databases.

The display units 14 are configured to display images received from the vending systems 2 to human operators in order to verify the age of potential purchasers of age-restricted items. The images include a person image of a potential purchaser and/or an image of (a part of) an identification document.

Controller 13 distributes the received images amongst the display units 14. The controller 13 may execute a round robin distribution process for efficient distribution of the images. In case more images are received than can be handled by the display units 14, the controller 13 is configured to manage a waiting cue of images. The controller 13 is also configured for providing, in the first verification phase, a person image of a potential purchaser to a first display unit 14 and, for the subsequent second verification phase, the person image and the document image on a second display unit 14, different from the first display unit 14.

The verification centre 3 also comprises a database 15 The database 15 may store the received images and other data received from the vending systems 2 for future use. The images can be retrieved from the database 15 when desired. Information from the database 15 can be used for sales transaction information for shop owners and allows authorities to check the transactions regarding age-restricted items. Furthermore, the database information may be used for statistical analysis.

The identification documents scanned by means of the document reader 11 may comprise a picture of the owner of the identification document in combination with information of the age of the owner. However, the documents may alternatively comprise information from which the age of the owner can be derived, e.g. at the age verification centre 3. The age of the owner may e.g. be derived from information already stored in the database 15 or by making a connection to an external system (not shown) from which the age of the owner of the identification document can be derived.

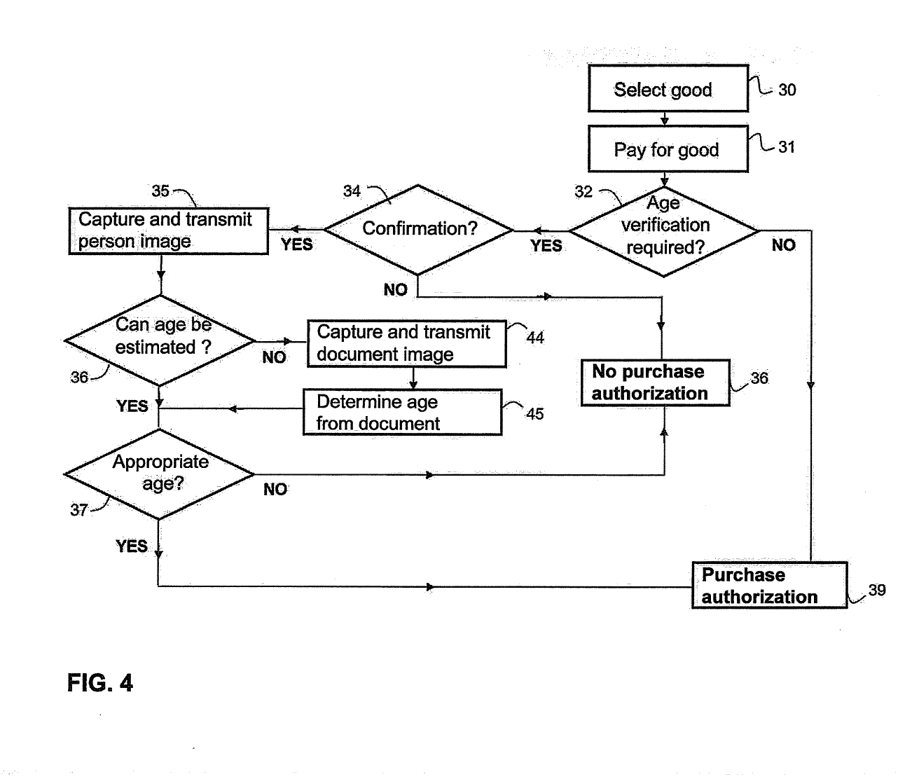

FIGS. 3 and 4 illustrate a method of operating the system 1 of FIG. 1. In particular, FIG. 3 is a communication diagram between a potential purchaser P, the vending system 2 and the age verification centre 3. FIG. 4 represents a flow chart illustrating steps/states of the method.

It will be assumed that the potential purchaser P arrives at the vending machine 2 and desires to purchase a good G.

In a first step 30, the person P makes a selection of the good G by operating the selection means 6 of the vending machine 5. The person P may also be required to pay for the good G in step 31 using payment means 8.

The processor 20 processes the selection signal (and possibly the payment signal) and determines in step 32 that the good G is an age-restricted good that requires an age verification procedure. Person P is informed of this finding by means of the display 7, possibly in combination with other legally required information in step 33, and his confirmation is determined in step 34. Person P may operate the confirmation button 9 in step 35 to signal his approval of being subjected to the age verification procedure. If the person does not confirm participation in the age verification procedure, authorization to purchase the age-restricted good is refused (step 36).

If person P confirms his intent to participate in step 34, the video camera 10 is subsequently activated in order to capture a person image of the person P. The person image is transmitted from the vending system 2 to the age verification centre 3 (step 35).

The person image is received by controller 13 and distributed to an available display unit 14. From the person image, it is determined (e.g. by a human operator or an automated process) whether the age can be estimated (step 36) and, if so, whether the person P has the appropriate age for purchasing good G (step 37).

As mentioned before, in most cases the live person image will be sufficient to assess whether or not person P should be authorized to make the purchase.

If the person P is estimated to have the appropriate age, a purchase authorization signal is transmitted to the vending system 2 (step 38) and purchase is authorized (step 39). The selected item G may then be made available to person P via disposal tray 4 of vending machine 5 (step 40).

If from the person image it is determined that the person P does not have the appropriate age, a purchase denial signal is transmitted from the age verification centre 3 to the vending system 2 (step 41) resulting in not authorizing the purchase (step 36). It should be noted that the absence of a purchase authorization signal and/or an identification request signal may also be considered to constitute a purchase denial signal.

If it cannot be determined whether or not person P has the required age, an identification request signal is transmitted from the age verification centre 3 to the vending system 2 in step 42. The person image may meanwhile be stored in database 15.

Person P is informed, e.g. by means of the display 7 or by means of a speaker, that he should provide an identification document in order to further determine whether or not he is authorized to purchase the good G. Person P may provide an identification document containing his photograph and data from which his age can be derived in step 43. The identification document is provided to the document reader 11 to be captured in to obtain a document image. The document image is transmitted from the vending system 2 to age verification centre 3 over the network 12 (step 44).

The person image and document image are both displayed on a display unit 14 (which is not necessarily the same display unit that displayed the initial sole person image), in order to determine or derive the age of the potential purchaser from the document (step 45) and to check whether the potential purchaser is the legitimate owner of the identification document. The person image may be retrieved from database 15 or be retransmitted from the vending machine in combination with the document image. If the potential purchaser is of the appropriate age, the purchase authorization signal will be transmitted (step 38) and the good G will be provided to the purchaser P (step 40). Otherwise, a purchase denial signal will be transmitted (step 41).

The first age verification phase on the basis of the person image will be sufficient in a majority of cases. If the person would e.g. have the age of 50, the first age verification phase would already have resulted in receiving the purchase authorization signal. On the other hand, if the person would clearly be under-aged, the first age verification phase would have resulted in denying the authorization signal. The same would be true if the human operator would conclude that the age of the person was not sufficient in the second age verification phase on the basis of both the person image and the document image. Only if the second age verification phase is required, the potential purchasers are bothered by presenting an identification document.

1. A method of vending age-restricted goods from a vending system, said vending system comprising a vending machine and a video camera, or equivalent means, for capturing an image of a person, the method comprising the steps of:
capturing a person image of said person by said video camera;
transmitting said person image to an age verification centre;
receiving a purchase authorization signal from said age verification centre if it can be determined from said person image that said person is of the required age for purchasing said age-restricted good from said vending machine;
receiving a purchase denial signal from said age verification centre if it can be determined from said person image that said person is not of the required age for purchasing said age-restricted good from said vending machine;
receiving an identification request signal from said age verification centre in response to transmitting said person image only if it can not be determined from said person image whether said person has the required age for purchasing said good from said vending machine;
providing access to said age-restricted good only when said purchase authorization signal has been received.

2. The method according to claim 1, wherein said vending system further comprises a document reader configured for capturing an image of an identification document of said person, the method further comprising the steps of:
capturing a document image of said identification document in response to receiving said identification request signal;
transmitting said document image to said age verification centre;
receiving said purchase authorization signal from said age verification centre if it is determined from said document image that said person is of the required age for purchasing said age-restricted good from said vending machine;
receiving a purchase denial signal from said age verification centre if it is determined from said document image that said person is not of the required age for purchasing said age-restricted good from said vending machine;
providing access to said age-restricted good only when said purchase authorization signal has been received.

3. The method according to claim 1 or 2, wherein said vending system comprises a selector for selecting one or more goods from said vending machine, further comprising the step of capturing or transmitting said person image in response to selecting an age-restricted good from said vending machine by operating said selector.

4. The method according to claim 1 or 2, wherein said vending system further comprises a confirmation means, further comprising the step of capturing or transmitting said person image in response to operating said confirmation means.

5. The method according to claim 1 or 2, wherein said vending system further comprises payment means configured for payment of said age-restricted goods, further comprising the step of completing payment using said payment means before capturing or transmitting said person image.

6. A method of authorizing from an age verification centre vending of age-restricted goods from a vending machine, the goods being stored in a vending machine, the method comprising the steps of:
receiving a person image of a person desiring purchasing of an age-restricted good;
transmitting a purchase authorization signal from said age verification centre if it can be determined from said person image that said person is of the required age for purchasing said age-restricted good from said vending machine;
transmitting a purchase denial signal from said age verification centre if it can be determined from said person image that said person is not of the required age for purchasing said age-restricted good from said vending machine;
transmitting an identification request signal from said age verification centre in response to transmitting said person image only if it can not be determined from said person image whether said person has the required age for purchasing said good from said vending machine.

7. The method according to claim 6, further comprising the steps of:
receiving at said age verification centre a document image of an identification document of said person in response to transmitting said identification request signal;
transmitting said purchase authorization signal from said age verification centre if it is determined from said document image that said person is of the required age for purchasing said age-restricted good from said vending machine;
transmitting a purchase denial signal from said age verification centre if it is determined from said document image that said person is not of the required age for purchasing said age-restricted good from said vending machine.

8. The method according to claim 6 or 7, wherein said age verification centre comprises a connection module configured for connecting a plurality of vending systems over a network to said age verification centre and a plurality of display units for displaying at least one of said person image and said document image obtained form said vending systems, further comprising the step of distributing said received person images and document images among said display units.

9. The method according to claim 8, further comprising the step of displaying said person image on a first display unit and an associated document image on a second display unit, different from said first display unit.

10. A vending system configured for use in a method according to any one of claims 1-5.

11. An age verification centre configured for use in a method according to any one of claims 6-9.
